(19) United States
(12) Patent Application Publication
(10) Pub. No.: US 2002/0179729 A1
(43) Pub. Date: Dec. 5, 2002

(54) Drinking straw

(76) Inventor: Paul Daniel Sheedy, Artane (IE)

Correspondence Address: Anthony R Barkume, 20 Gateway Lane, Manorville, NY, 11949, US

(21) Appl. No.: 10/148,660

(22) PCT Filed: Dec. 13, 2000
(86) PCT No.: PCT/GB00/04768

(30) Foreign Application Priority Data
Dec. 14, 1999 (GB) 9929491.0

(51) Int. Cl. A61J 15/00

(52) U.S. Cl. 239/33

(57) ABSTRACT

A drinking straw (1) has a spherical transparent housing (2) formed part way up it in which there is a ball (3) which can be marked or decorated and when a drink is sucked up the straw (1) the ball (3) rotates.

The present invention relates to straw or the like in which there is a device which rotates when liquid is sucked up the straw.

Straws are used for drinking from glasses, containers etc. and, in order to make them more attractive to look at and more fun to use, they can be bent into shapes, loops and coloured etc. The use of such straws can encourage users, particularly if they are children, to drink more.

I have now devised an improved drinking straw.

According to the invention there is provided a drinking straw in which there is a housing, spaced apart from the ends of the drinking straw, with the interior of the housing forming part of the straw and in which housing there is a rotatable device so that, when fluid passes through the straw, the device is rotated by the passage of the fluid.

By the term drinking straw is meant any tubular conduit which can be used for drinking and can be made of any conventionally used material such as waxed paper, a plastics material such as polyethylene, polypropylene, polyvinylchloride a polyterephthalate etc. and the straw can be straight curved or any other shape.

The housing is preferably substantially spherical, with the straw offset from the centre of the housing. The housing is preferably substantially transparent so that the rotation of the device can be seen and the device can have a logo, trademark, pattern or design etc. on it which can be seen as it rotates.

Although a substantially spherical shape is preferred for the housing the housing can deviate from the spherical e.g. it can be a flattened sphere or have an ellipsoidal cross section or can be substantially cylindrical with the device inside the housing corresponding in shape to the housing so that it can rotate freely within the housing.

The device preferably fits within the housing with only a small gap between the device and the housing.

In a preferred embodiment of the invention the device is substantially spherical i.e. it is ball shaped, and fits within a substantially spherical housing.

Preferably there is channel formed round the outside of the device in which there are vanes, so that the passage of a fluid impinges on the vanes and makes it easier to rotate the ball.

Although the straw is primarily for use with drinking liquids it can function by blowing or sucking air through it and can be used as a toy or amusement in its own right.

The invention is illustrated in the accompanying drawings in which:

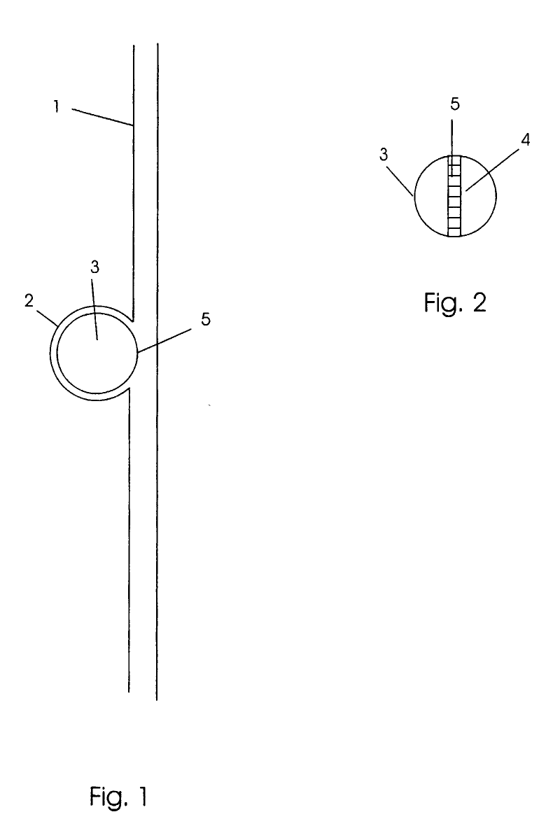

FIG. 1 is a side view of the drinking straw and

FIG. 2 is plan view of the ball

Referring to FIG. 1 a drinking straw (1) has a transparent spherical housing (2) formed in it so fluid passing through the straw passes through the housing (2). Within the housing (2) there is spherical ball (3) which is free to rotate within the housing.

Referring to FIG. 2 the ball (3) has a channel (4) formed around a circumference in which there are vanes (5). The ball is positioned in the housing so that fluid passing through the straw will impinge on the vanes.

In use fluid e.g. a drink, is sucked up the straw and impinges on the vanes (5) of the ball (3) and causes the ball to rotate and the ball and its rotation is visible from outside the housing.

In use a range of visual effects can be achieved by colouring or patterning the ball or having a logo or words etc. on the ball.

1. A drinking straw in which there is a housing spaced apart from the ends of the drinking straw, with the interior of the housing forming part of the straw and in which housing there is a rotatable device so that, when fluid passes through the straw, the device is rotated by the passage of the fluid.

2. A drinking straw as claimed in claim 1 in which the housing is substantially spherical and the straw is offset from the centre of the housing.

3. A drinking straw as claimed in claim 1 or 2 in which the housing is substantially transparent and the device has markings on it which can be seen as it rotates.

4. A drinking straw as claimed in any one of claims 1 to 3 in which the device is substantially spherical and fits within a substantially spherical housing

5. A drinking straw as claimed in claim 4 in which there is channel formed round the outside of the device in which channel there are vanes so that the passage of a fluid through the straw impinges on the vanes.

6. A drinking straw as hereinbefore described with reference to the drawings.
